(19) United States
(12) Patent Application Publication
(10) Pub. No.: US 2016/0048750 A1
(43) Pub. Date: Feb. 18, 2016

(54) RFID TAG

(71) Applicant: FUJITSU LIMITED, Kawasaki-shi (JP)

(72) Inventor: Takayoshi Matsumura, Yokohama (JP)

(21) Appl. No.: 14/751,240

(22) Filed: Jun. 26, 2015

(30) Foreign Application Priority Data
Aug. 15, 2014 (JP) 2014-165483
Sep. 22, 2014 (JP) 2014-192310

(51) Int. Cl. G06K 19/077

(52) U.S. Cl. CPC G06K 19/07728; G06K 19/07745

(57) ABSTRACT

A disclosed RFID tag includes: a base member; a semiconductor chip mounted over the base member; and an external member covering the base member and the semiconductor chip, a surface of the external member being provided with a groove at a position away from the semiconductor chip. The groove serves as a fold when the external member is folded.

### CROSS-REFERENCE TO RELATED APPLICATION(S)

This application is based upon and claims the benefit of priority of the prior Japanese Patent Application No. 2014-165483, filed on Aug. 15, 2014, and the Japanese Patent Application No. 2014-192310, filed on Sep. 22, 2014, the entire contents of which are incorporated herein by reference.

### FIELD

The embodiments discussed herein are related to an RFID tag.

### BACKGROUND

Along with the advance of the information processing technology and the reduction in size of the semiconductor devices in recent years, RFID (Radio Frequency Identifier) tags are used in various situations in the society.

The RFID tag includes a semiconductor chip and an antenna, and the semiconductor chip is operated by an electromagnetic wave received by the antenna. The semiconductor chip stores ID information on an article which is the object of management, and a user manages the article by reading the ID information with an external device.

The object of management includes various articles. For example, merchandise in a shop, transport objects, books, linens, and the like can be managed by using the RFID tags.

Specifications of the RFID tags are optimized depending on the types of the objects of management. For example, when the RFID tags are attached to linens such as clothes and sheets, the RFID tags is provided with flexibility so that the RFID tags can withstand various pressures applied thereto at the time of washing the linens.

FIG. 1 is a cross-sectional view schematically illustrating a process to extract water from linens at the time of washing.

In the example illustrated in FIG. 1, linens 2 are put into a water extraction tank 1 and then water is extracted from the linens 2 by application of a pressure from above. When the RFID tags are too rigid, the RFID tags may get broken by the pressure in this process. Accordingly, it is preferable to provide sufficient flexibility to the RFID tags attached to the linens 2.

Likewise, a pressure is also applied to the RFID tags during a process of ironing the linens, and hence it is also preferable to use the flexible RFID tags.

The techniques related to the present application are disclosed in Japanese Laid-open Patent Publications Nos. 2012-212198, 2010-122764, 2003-187201, 2012-84050, and 2011-221599.

### SUMMARY

According to one aspect discussed herein, there is provided an RFID tag comprising: a base member; a semiconductor chip mounted over the base member; and an external member covering the base member and the semiconductor chip, a surface of the external member being provided with a groove at a position away from the semiconductor chip, the groove serving as a fold when the external member is folded.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a cross-sectional view schematically illustrating a process to extract water from linens at the time of washing;

FIG. 2 is a cross-sectional view of an RFID tag used for an examination;

FIG. 3 is a plan view of the RFID tag used for then examination;

FIGS. 4A and 4B are plan views of RFID tags folded by washing;

FIGS. 5A and 5B are plan views of RFID tags which are folded by washing but semiconductor chips therein are kept from cracking;

FIG. 6 is a cross-sectional view of an RFID tag according to a first embodiment;

FIG. 7 is a plan view of the RFID tag according to the first embodiment;

FIG. 8 is a perspective view of the RFID tag according to the first embodiment;

FIG. 9 is a side view of an RFID tag not provided with grooves, which is bowed by an external force;

FIG. 10 is a perspective view of the RFID tag according to the first embodiment in the case where an external force is applied thereto;

FIG. 11 is a perspective view of the RFID tag according to the first embodiment in the case where a greater external force is applied thereto;

FIG. 12 is a perspective view of an RFID tag according to a first example of the first embodiment;

FIG. 13 is a perspective view of an RFID tag according to a second example of the first embodiment;

FIG. 14 is a perspective view of an RFID tag according to a third example of the first embodiment;

FIG. 15 is a first perspective view for explaining the folds formed in the RFID tag according to the third example of the first embodiment;

FIG. 16 is a second perspective view for explaining the folds formed in the RFID tag according to the third example of the first embodiment;

FIG. 17 is a perspective view of an RFID tag according to a fourth example of the first embodiment;

FIG. 18 is a perspective view of an RFID tag according to a fifth example of the first embodiment;

FIG. 19 is a plan view of an RFID tag according to a sixth example of the first embodiment;

FIG. 20 is a cross-sectional view of an RFID tag according to a seventh example of the first embodiment, which is taken along its longitudinal direction;

FIG. 21 is a cross-sectional view of an RFID tag according to an eighth example of the first embodiment, which is taken along its longitudinal direction;

FIG. 22 is a cross-sectional view of an RFID tag according to a ninth example of the first embodiment, which is taken along its longitudinal direction;

FIG. 23 is a cross-sectional view of an RFID tag according to a tenth example of the first embodiment, which is taken along its longitudinal direction;

FIG. 24 is a cross-sectional view of an RFID tag according to an eleventh example of the first embodiment, which is taken along its longitudinal direction;

FIGS. 25A to 25E are cross-sectional views of the RFID tag of the first embodiment that is in the course of manufacturing;

FIG. 26 is a perspective view of an RFID tag according to a second embodiment;

FIG. 27 is an enlarged plan view of the RFID tag for explaining folds in the second embodiment; and

FIG. 28 is a perspective view for explaining another example of a positional relation between a chip mounting region and folds in the second embodiment.

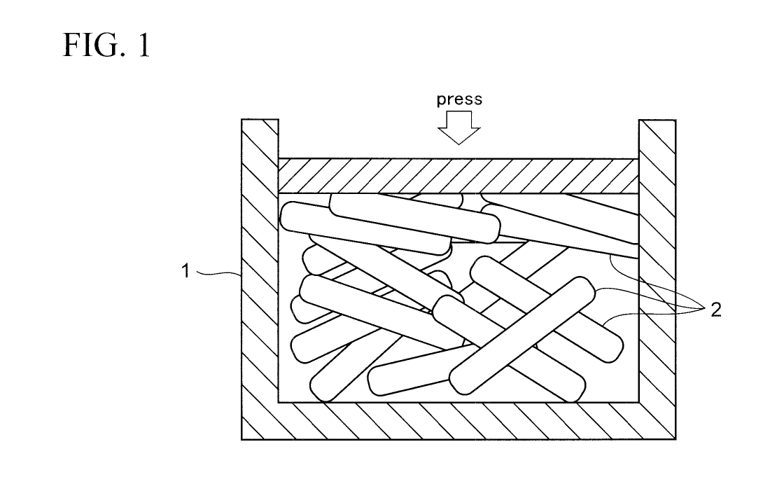

### DESCRIPTION OF EMBODIMENTS

Prior to the descriptions of embodiments, considerations made by the inventor of the present application will be explained.

As mentioned above, by providing flexibility to the RFID tag for linen, it is possible to prevent the RFID tag from being broken since its shape is deformed in response to the pressures at the time of washing. On the other hand, such deformation in shape may cause a crack of a semiconductor chip in the RFID tag.

The inventor of the present application examined as to how the RFID tag is folded by the pressures applied thereto at the time of washing.

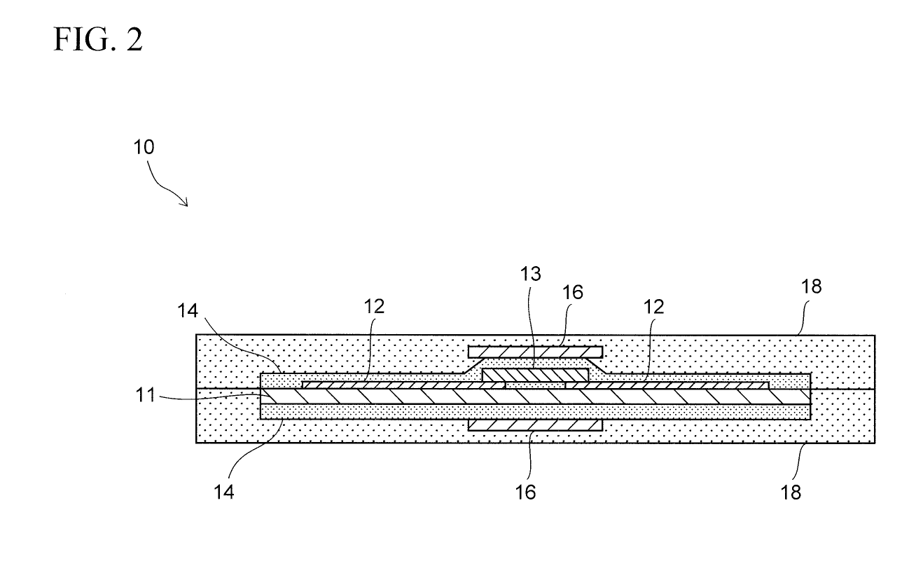

FIG. 2 is a cross-sectional view of an RFID tag used in the examination.

This RFID tag 10 includes an inlet base member made of a resin such as PET (polyethylene terephthalate), and an antenna 12 provided on a surface of the inlet base member 11. A semiconductor chip 13 is mounted on the antenna 12, and a protective sheet 14 is attached onto the semiconductor chip 13.

The protective sheet 14 has a function to protect the antenna 12 and the semiconductor chip 13. For example, a PET sheet can be used as the protective sheet 14.

Note that another protective sheet 14 is also attached to a back face of the inlet base member 11 on which the semiconductor chip 13 is not mounted.

Then, reinforcing members 16 are provided on the respective protective sheets 14 on the front and back sides of the inlet base member 11.

The reinforcing members 16 are resin plates made of PET and the like, and are provided at positions to cover the semiconductor chip 13 from the front and back sides thereof.

Moreover, elastic sheets such as rubber sheets are provided as external members 18 onto the reinforcing members 16 of the front and back sides.

By using the elastic sheets as the external members 18 in this manner, flexibility is provided to the RFID tag 10

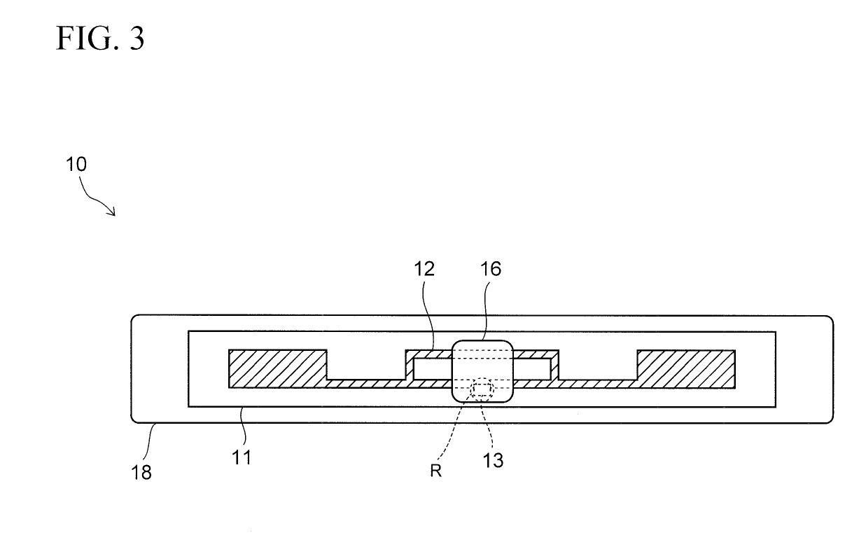

FIG. 3 is a plan view of the RFID tag 10.

As illustrated in FIG. 3, the RFID tag 10 has an elongated shape in a plan view. Moreover, a chip mounting region R is provided in the vicinity of the center of the RFID tag 10, and the semiconductor chip 13 is mounted on the region R.

The RFID tags 10 were attached to linens and washed together with the linens. As a consequence, folds L were provided to the RFID tags 10 as described below.

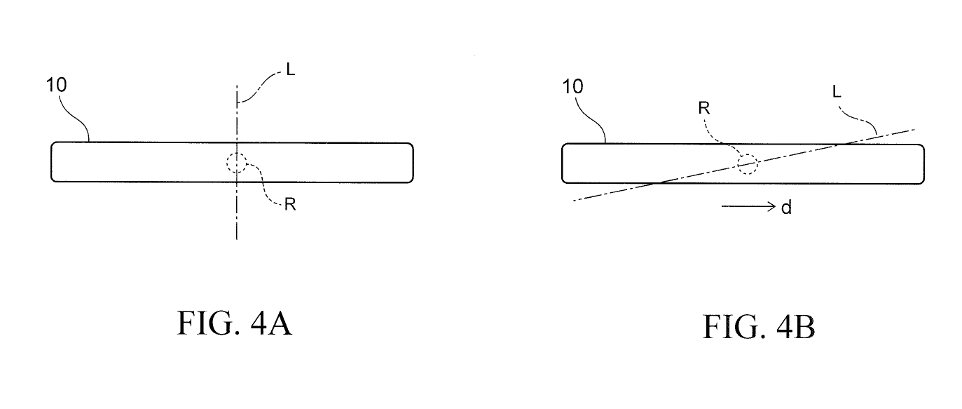

FIGS. 4A and 4B are plan views of the RFID tags 10 provided with folds L by washing.

In the example of FIG. 4A, a fold L parallel to a short side of the RFID tag 10 is provided in such a way as to pass through the chip mounting region R. The fold L is thought to be formed as a result of application of a force in such a way as to fold the RFID tag 10 along the fold L.

Meanwhile, in the example of FIG. 4B, a fold L oblique to a longitudinal direction d of the RFID tag 10 is provided in such a way as to pass through the chip mounting region R. The fold L is thought to be formed as a result of application of a force in such a way as to twist the RFID tag 10.

In the both examples of FIGS. 4A and 4B, the semiconductor chips 13 (see FIG. 3) located in the chip mounting region R were cracked since the folds L pass through the regions R. The inventor of the present application confirmed that the probability of the semiconductor chips 13 to be cracked in this manner is about 1/1000.

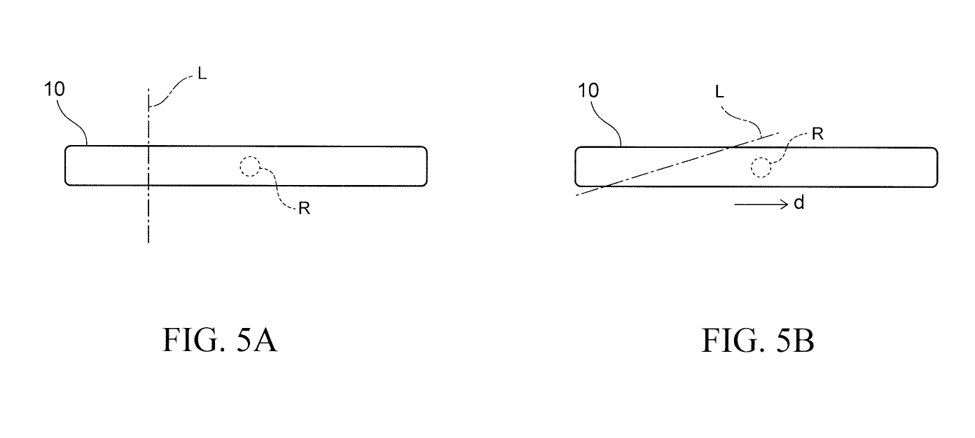

In the meantime, FIGS. 5A and 5B are plan views of the RFID tags 10 which were provided with folds L by washing but the semiconductor chips 13 does not cracked.

In the example of FIG. 5A, a fold L parallel to the short side of the RFID tag 10 is provided as in the case of FIG. 4A

Then, in the example of FIG. 5B, a fold L oblique to the longitudinal direction d of the RFID tag 10 is provided as in the case of FIG. 4B.

However, unlike the examples of FIGS. 4A and 4B, the folds L are located away from the chip mounting regions R in the examples of FIGS. 5A and 5B. Accordingly, the semiconductor chips 13 were not cracked.

In addition, although the RFID tag 10 is provided with the antenna 12 (see FIG. 3), the antenna was not disconnected by the folds L and the reliability of the RFID tag 10 was less reduced.

From this result, it was revealed that the dislocation of the folds L away from the chip mounting region R was effective to prevent the semiconductor chip from cracking and thereby to improve reliability of the RFID tag 10.

In the followings, the embodiments will be described.

### First Embodiment

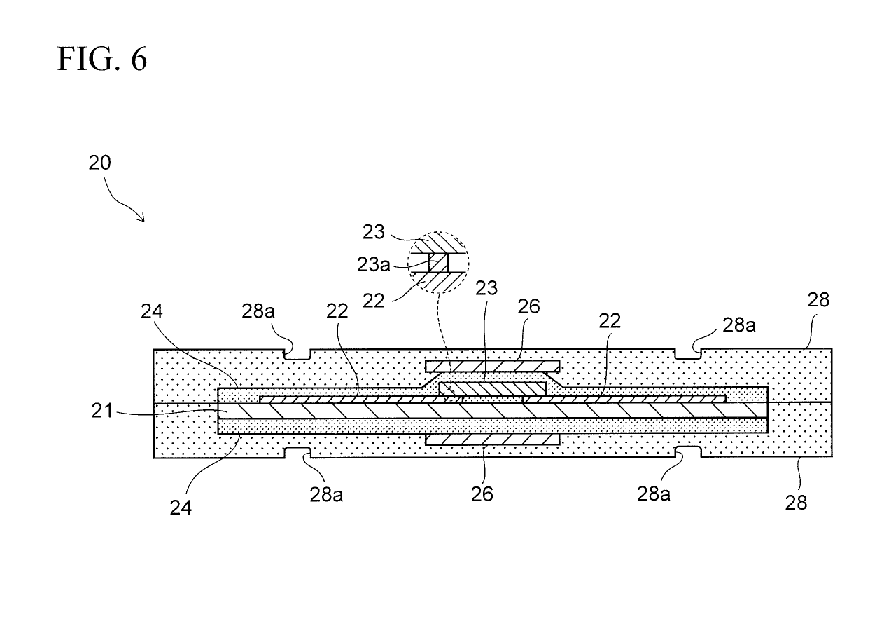

FIG. 6 is a cross-sectional view of an RFID tag according to a first embodiment.

This RFID tag 20 is a flexible tag to be attached to linen such as clothes, and includes an inlet base member 21 and a conductive pattern 22 provided on a surface of the inlet base member 21.

The inlet base member 21 is a flexible resin sheet. In this example, a PET sheet having a thickness of about 30 μm to 100 μm is used as the inlet base member 21.

Meanwhile, the conductive pattern 22 is a silver pattern, for example, and is served as an antenna to communicate with an external device.

A semiconductor chip 23 is mounted on the conductive pattern 22. How to connect the conductive pattern 22 and the semiconductor chip 23 is not particularly limited. In this example, the conductive pattern 22 is connected to the semiconductor chip 23 through terminals 23a such as solder bumps and gold bumps.

Moreover, a protective sheet 24 such as a PET sheet is attached onto the conductive pattern 22 and the semiconductor chip 23. The conductive pattern 22 and the semiconductor chip 23 are protected by the protective sheet 24.

Note that another protective sheet 24 is also attached to a back face of the inlet base member 21 on which the semiconductor chip 23 is not mounted.

The protective sheet 24 preferably has a sufficiently small thickness so as not to damage flexibility of the RFID tag 20. In this example, the thickness of the protective sheet 24 is about 50 μm to 300 μm.

Then, reinforcing members 26 made of a resin are provided on the respective protective sheets 24 on the front and back sides of the inlet base member 21. Thus, the semiconductor chip 23 is covered with the reinforcing member 26.

The reinforcing member 26 has a function to reinforce the RFID tag 20 around the semiconductor chip 23, and thereby to prevent the RFID tag 20 around the semiconductor chip 23 from being bent by an external force.

As long as the reinforcing member 26 has this function, the material and the thickness of the reinforcing member 26 are not particularly limited. However, in order to effectively reinforce the RFID tag 20, it is preferable to use the reinforcing members 26 formed from the material with the thickness that achieves higher rigidity than that of the inlet base member 21. From this point of view, a PET plate having a thickness of 100 μm to 300 μm is used as the reinforcing member 26 in the present embodiment.

Here, materials other than PET usable as the material of the reinforcing members 26 include PEN (polyethylene naphthalate) and polyimide, for example.

Although the reinforcing members 26 are respectively provided on the front side and the back side of the semiconductor chip 23 in this example, the reinforcing member 26 may be provided only on one of the front side and the back side instead.

Then, elastic sheets such as rubber sheets are provided as external members 28 onto the reinforcing members 26 of the front and back sides. By using the elastic sheets as the external members 28 in this manner, flexibility is provided to the RFID tag 20 as described previously.

Here, the flexibility of the RFID tag 20 will be lost when the external members 28 are too thick. In the present embodiment, the flexibility of the RFID tag is maintained by setting the thickness of the external member 28 in a range from 0.5 mm to 2.0 mm.

Furthermore, grooves 28a to serve as folds when the RFID tag 20 is folded are provided in a surface of the external member 28.

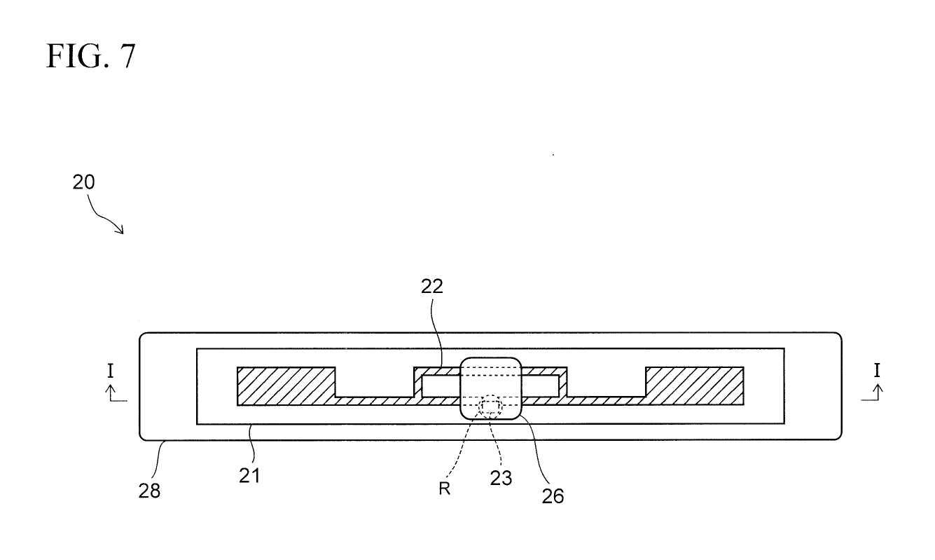

FIG. 7 is a plan view of the RFID tag 20.

Here, FIG. 6 described above corresponds to a cross-sectional view taken along the I-I line in FIG. 7. It is to be noted, however, that the protective sheet 24 and the external member 28 on the upper side are omitted in FIG. 7.

As illustrated in FIG. 7, the RFID tag 20 has an elongated shape, and a chip mounting region R to mount the semiconductor chip 23 is provided in the vicinity of the center of the RFID tag 20.

The reinforcing member 26 has a rectangular shape in a plan view, and is provided at a position to cover the semiconductor chip 23.

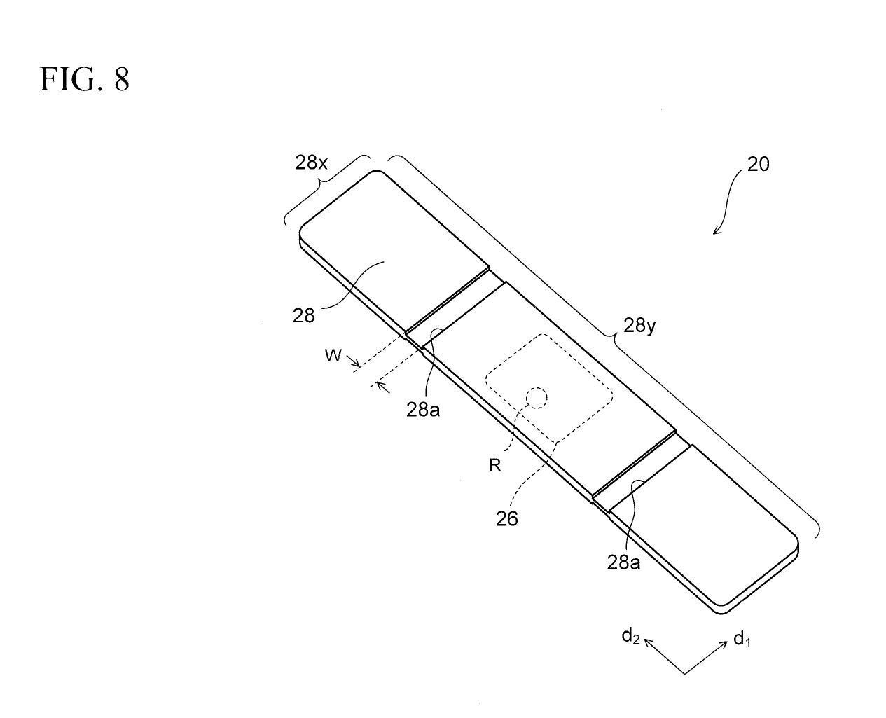

FIG. 8 is a perspective view of the RFID tag 20.

In FIG. 8 and the subsequent drawings, a lateral direction of the elongated RFID tag 20 is indicated with d₁, while a longitudinal direction orthogonal to the direction d₁ is indicated with d₂.

Then, each groove 28a extends straight in the lateral direction d₁ of the external member 28 and is situated at a position away from the chip mounting region R.

Although the size of the external member 28 is not particularly limited, a length of a short side 28x of the external member 28 is set to about 6 mm and a length of a long side 28y of the external member 28 is set to about 51 mm in this example.

Next, a function of the grooves 28a will be described.

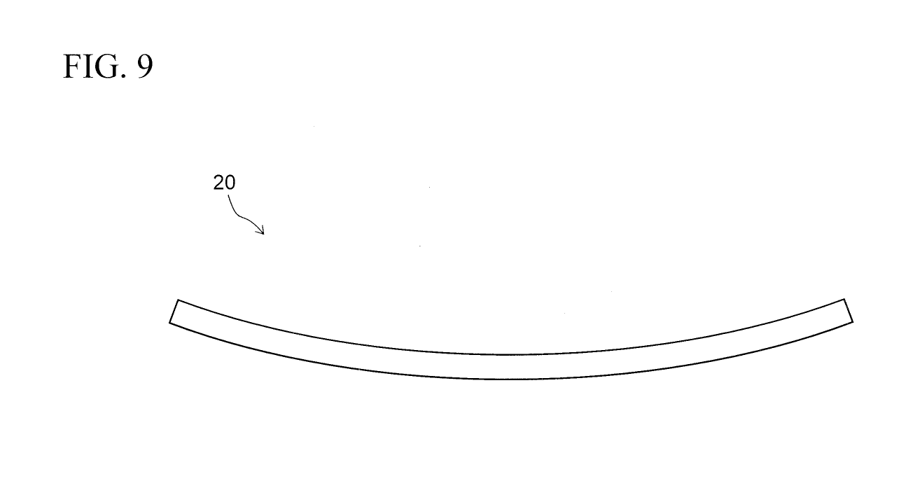

FIG. 9 is a side view of the RFID tag 20 that is not provided with the grooves 28a, which is bowed by an external force.

A bending moment is generated in the RFID tag 20 in the bowed state in such a way as to counteract the external force. When the RFID tag 20 is provided with no grooves 28a as illustrated in FIG. 9, mechanical strength is almost the same at any portions of the RFID tag 20. Accordingly, there exists no portion in the RFID tag 20 which is significantly deformed by the bending moment.

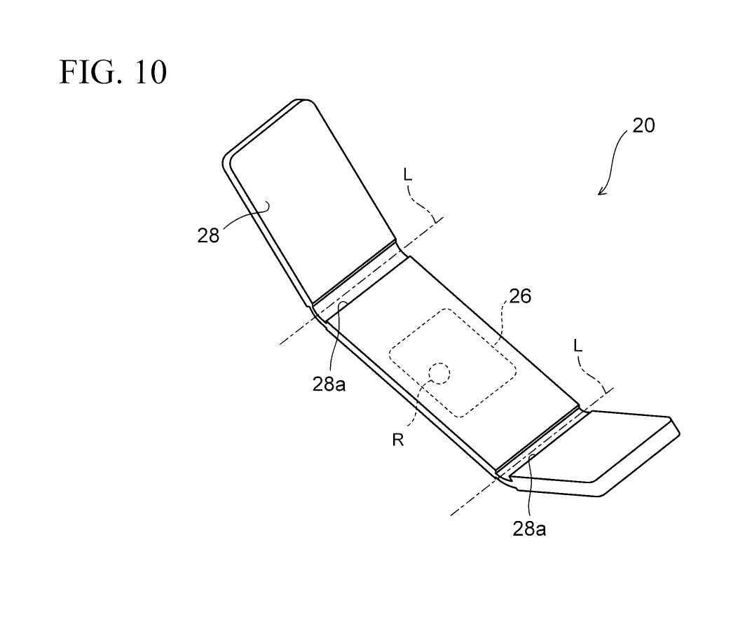

Meanwhile, FIG. 10 is a perspective view of the RFID tag 20 provided with the grooves 28a as in the present embodiment, illustrating the case where the external force is applied to the RFID tag 20.

The portions of the RFID tag 20 where the grooves 28a is provided have lower mechanical strength as compared to the other portions. Accordingly, when the external force is applied as illustrated in FIG. 10, the grooves 28a acts as folds L and the RFID tag 20 is folded.

In order to make the RFID tag 20 easily foldable in this manner, it is preferable to form the groove 28a across the entire width of the RFID tag 20 as illustrated in FIG. 10.

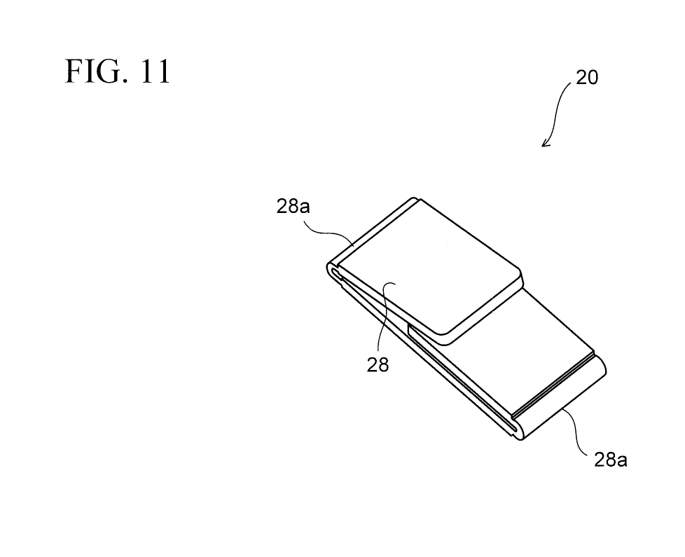

Moreover, when the external force applied to the RFID tag 20 is greater, the RFID tag 20 is lapped at the grooves 28a as illustrated in FIG. 11.

Each groove 28a functions as a fold of the RFID tag 20 as described above. As long as this function is maintained, a width W (see FIG. 8) and a depth of the groove 28a are not limited. In the present embodiment, the width W of the groove 28a is set about 1 mm to 2 mm, and the depth of the groove 28a is set about 0.2 mm to 0.3 mm.

As described above, the RFID tag 20 is folded preferentially at the grooves 28a. Therefore, the portions of the RFID tag 20 other than the grooves 28a are less likely to be folded by the external force.

Accordingly, by locating the grooves 28a away from the chip mounting region R as in the present embodiment, it is possible to reduce a risk of a crack of the semiconductor chip 23 in the region R even when the RFID tag 20 is folded by the external force.

Specifically, the RFID tags 20 attached to linen such as clothes are frequently folded by various pressures at the time when the linen is washed as described previously. Therefore, the application of the present embodiment is a highly practical for the RFID tags 20 attached to linen in order to prevent the semiconductor chips 23 from cracking.

In addition, since the groove 28 is provided in the uppermost external member 28 that is prone to fold, the RFID tag 20 can be made more foldable than the case where the groove is formed in the inner portions of the RFID tag 20.

Moreover, since the rubber serving as the material of the external members 28 is sufficiently elastic, the risk is reduced that the external member 28 break off at the groove 28a when the RFID tag 20 is folded.

Furthermore, the thickness of the external member 28 is reduced only at the grooves 28a. Accordingly, at the portions other than the grooves 28a, the base member 21 and the conductive pattern 22 are protected by the sufficiently thick external member 28.

Note that the configuration of the grooves 28a is not limited only to the above. In the followings, various examples of other configurations of the groove 28a are described.

### First Example

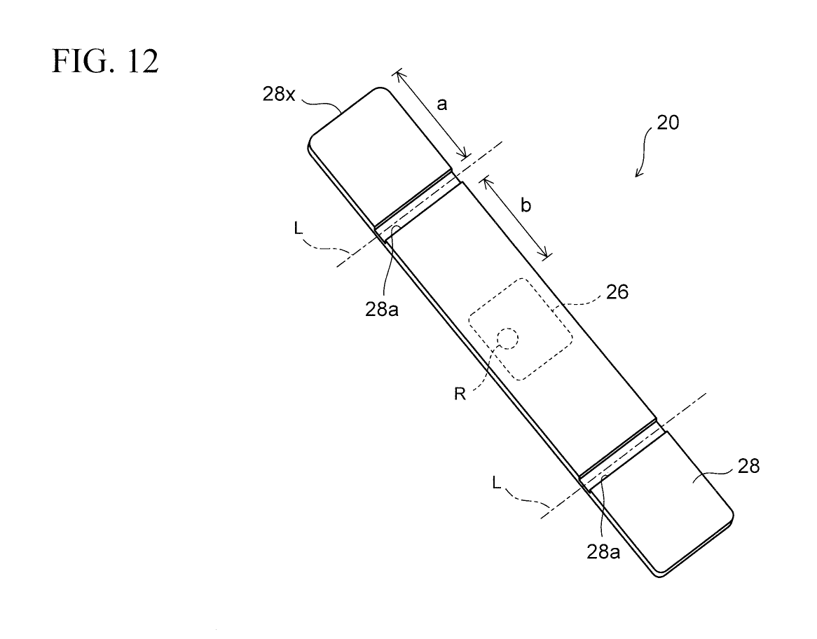

FIG. 12 is a perspective view of an RFID tag 20 according to a first example.

In this example, the reinforcing member 26 and the chip mounting region R are provided at a central portion of the external member 28.

Then, a distance a from one short side 28x of the external member 28 to the groove 28a is set equal to a distance b from the reinforcing member 26 to the groove 28a.

Since the reinforcing member 26 is highly rigid and is hardly bent, the bending moment is thought to become the maximum at a portion of the RFID tag 20 located at equal distances from the reinforcing member 26 and from the short side 28x when the external force acts on the RFID tag 20. In this example, the groove 28a is provided at the portion where the distance from the reinforcing member 26 and the distance from the short side 28x are equal. Therefore, the groove 28a acts as the fold L and the RFID tag 20 can be easily folded, which in turn reduce the risk that the RFID tag 20 is folded at the portions other than the groove 28a.

Moreover, in this example, the groove 28a is provided at the position away from the reinforcing member 26 so as to prevent the reinforcing member 26 and the groove 28a from overlapping each other. Therefore, when the RFID tag 20 is bent at the grooves 28a, it is possible to prevent the highly rigid reinforcing members 26 from disturbing the bending of the RFID tag 20.

### Second Example

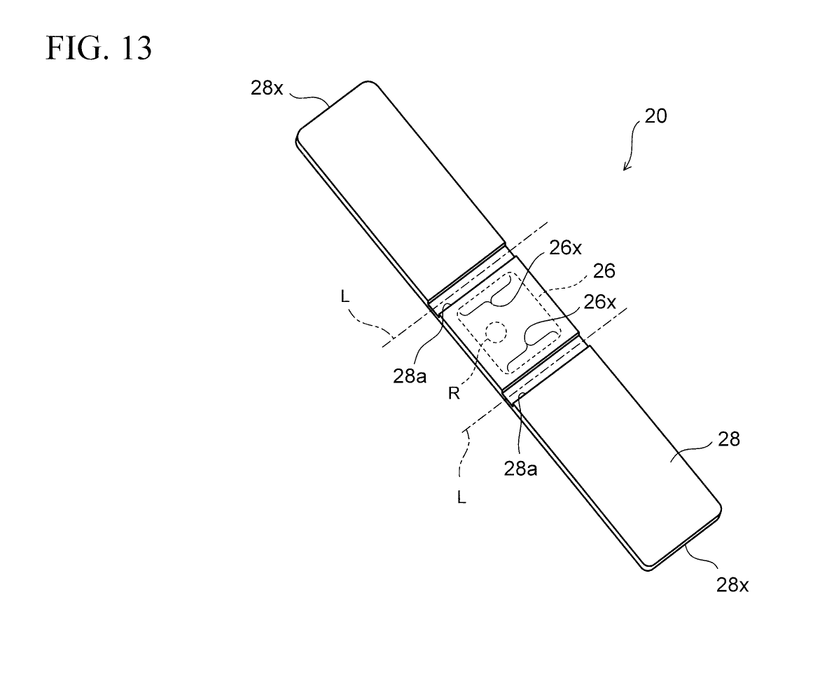

FIG. 13 is a perspective view of an RFID tag 20 according to a second example.

In this example as well, the reinforcing member 26 and the chip mounting region R are provided at the central portion of the external member 28.

However, in this example, the groove 28a is provided closer to the reinforcing member 26 than the short side 28x.

When the external force acts on the RFID tag 20, a stress is thought to be concentrated on the edge 26x of the reinforcing member 26. Accordingly, by providing the groove 28a closer to the reinforcing member 26, the RFID tag 20 can be easily folded at the groove 28a serving as the folds L by the stress concentrated on the edges 26x. Thus, the risk is reduced that the RFID tag 20 is folded at the portions other than the groove 28a.

Moreover, the groove 28a is located at the positions away from the reinforcing member 26 as in the first example. Accordingly, it is possible to prevent the highly rigid reinforcing member 26 from disturbing the bending of the RFID tag 20.

### Third Example

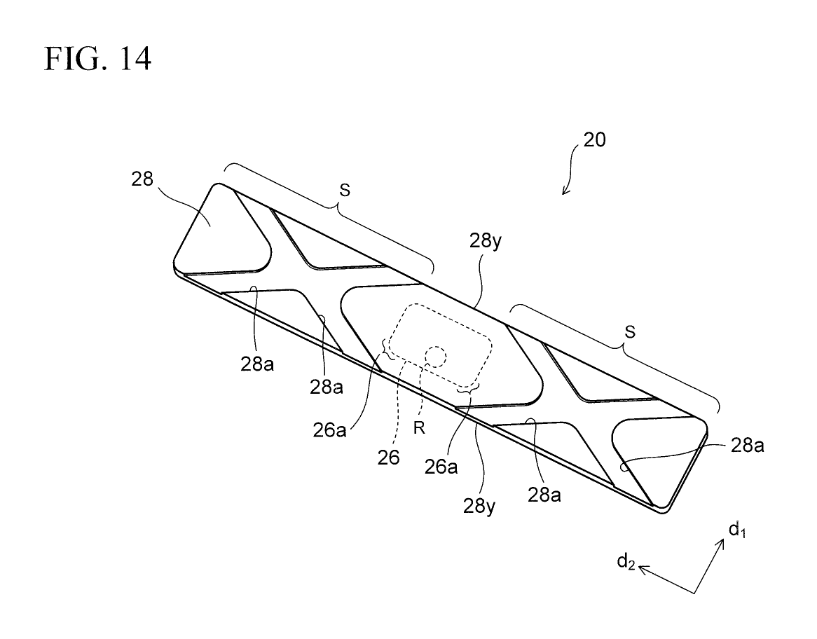

FIG. 14 is a perspective view of an RFID tag 20 according to a third example.

In this example as well, the reinforcing member 26 and the chip mounting region R are provided at the central portion of the external member 28.

However, in this example, straight grooves 28a are provided to extend obliquely to the longitudinal direction d₂ of the external member 28. In addition, two oblique grooves 28a are provided in each of two regions S at the both side of the reinforcing member 26, and these grooves 28a are made to cross each other.

Here, each groove 28a extends from one long side 28y of the external member 28 to the other long side 28y. Moreover, the groove 28a and the long side 28y are made to cross each other in the vicinity of a corner 26a of the reinforcing member 26.

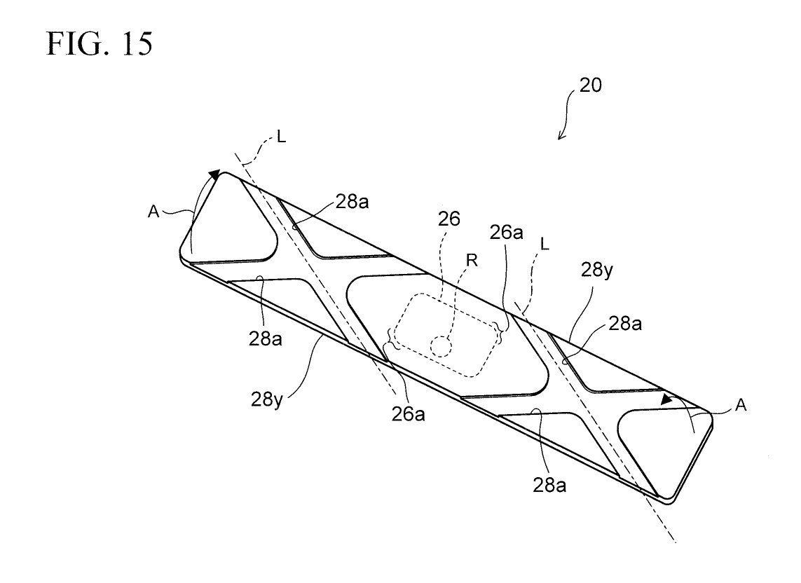

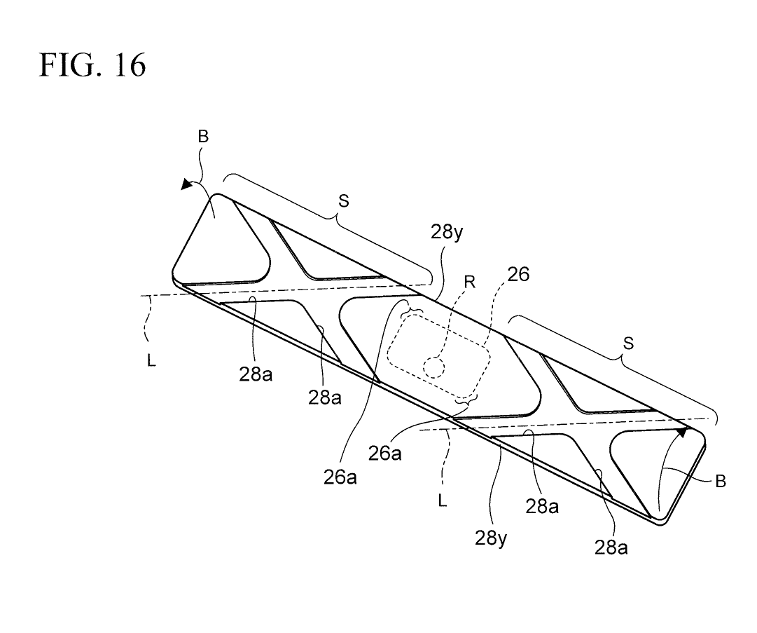

FIG. 15 and FIG. 16 are perspective views for explaining the folds L formed in the RFID tag 20 of this example.

Since the grooves 28a are obliquely provided in this example, even when the RFID tag 20 is twisted in directions indicated with arrows A in FIG. 15, the RFID tag 20 is folded while acting the grooves 28a as the folds L. Hence, the chip mounting region R located away from the grooves 28a is not bent as a consequence.

Moreover, since each of the regions S includes the two grooves 28a with different orientations in this example, even when the RFID tag 20 is twisted in directions indicated with arrows B in FIG. 16, the RFID tag 20 is folded while acting the grooves 28a different from those in FIG. 15 as the folds L.

Accordingly, in this example, the semiconductor chip 23 in the chip mounting region R can be prevented from cracking even when the RFID tag 20 is twisted in any of the directions of the arrows A (FIG. 15) and the directions of the arrows B (FIG. 16).

Note that when the RFID tag 20 is twisted, a stress is thought to be concentrated on the corners 26a of the reinforcing members 26. Accordingly, by causing the grooves 28a and the long sides 28y to cross one another in the vicinity of the corners 26a as in this example, the RFID tag 20 is easily folded at the grooves 28a by the stress concentrated on the corners 26a. As a consequence, it is possible to reduce a risk that the RFID tag 20 is folded at portions other than the grooves 28a.

### Fourth Example

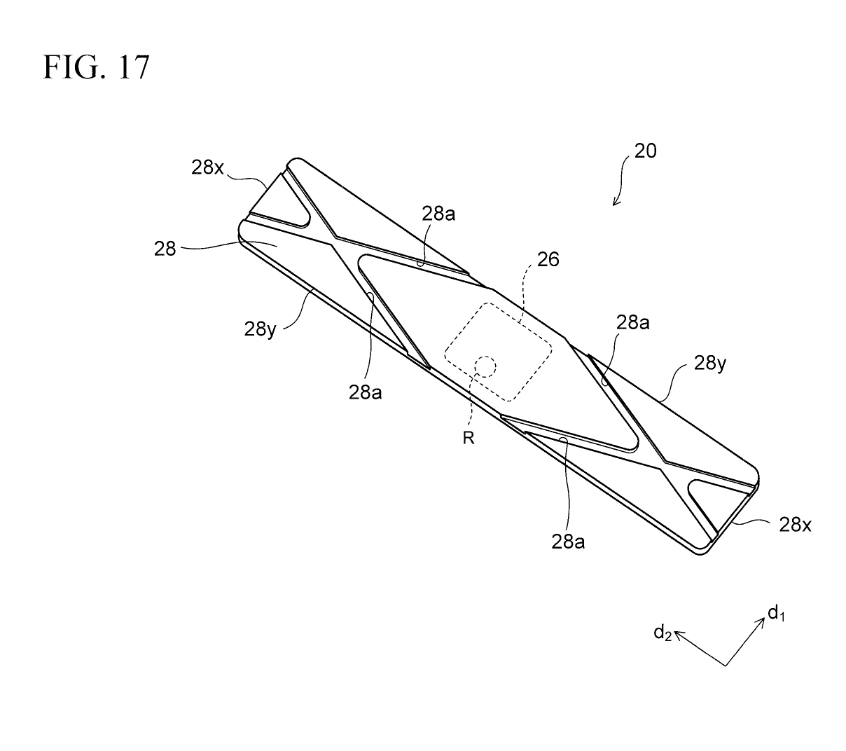

FIG. 17 is a perspective view of an RFID tag 20 according to a fourth example.

Similar to the third example, the grooves 28a are provided obliquely to the longitudinal direction d₂ of the external member 28 in this example.

However, in this example, the groove 28a extends from the short side 28x of the external member 28 to the long side 28y.

### Fifth Example

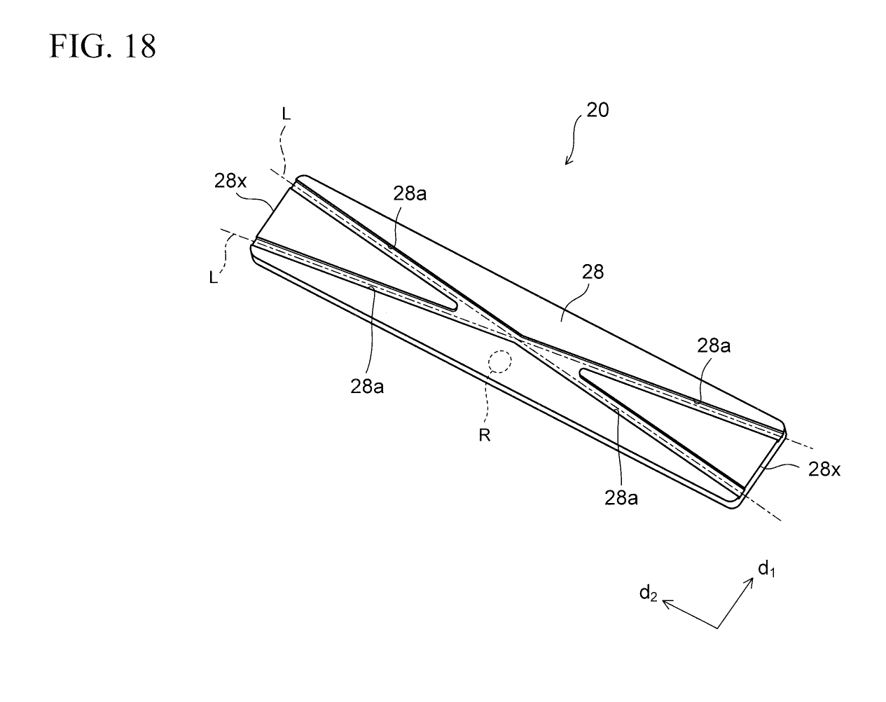

FIG. 18 is a perspective view of an RFID tag 20 according to a fifth example.

Similar to the third example and the fourth example, the grooves 28a are provided obliquely to the longitudinal direction d₂ of each external member 28 in this example.

However, in this example, the groove 28a is extending from one of the short sides 28x of the external member 28 to the other short side 28x, and an intersection of the two grooves 28a is located at the central portion of the external member 28.

Note that it is preferable to locate the grooves 28a away from the reinforcing member 26 (see FIG. 7) in order for the RFID tag 20 to be bent easily along the grooves 28a as described above. Nevertheless, when the RFID tag 20 is partitioned into small regions by the grooves 28a and it is difficult to provide the reinforcing member 26 in those small regions in such a way as to be located away from the grooves 28a, then the reinforcing member 26 may be omitted. This is also the case for a sixth example to be described below.

### Sixth Example

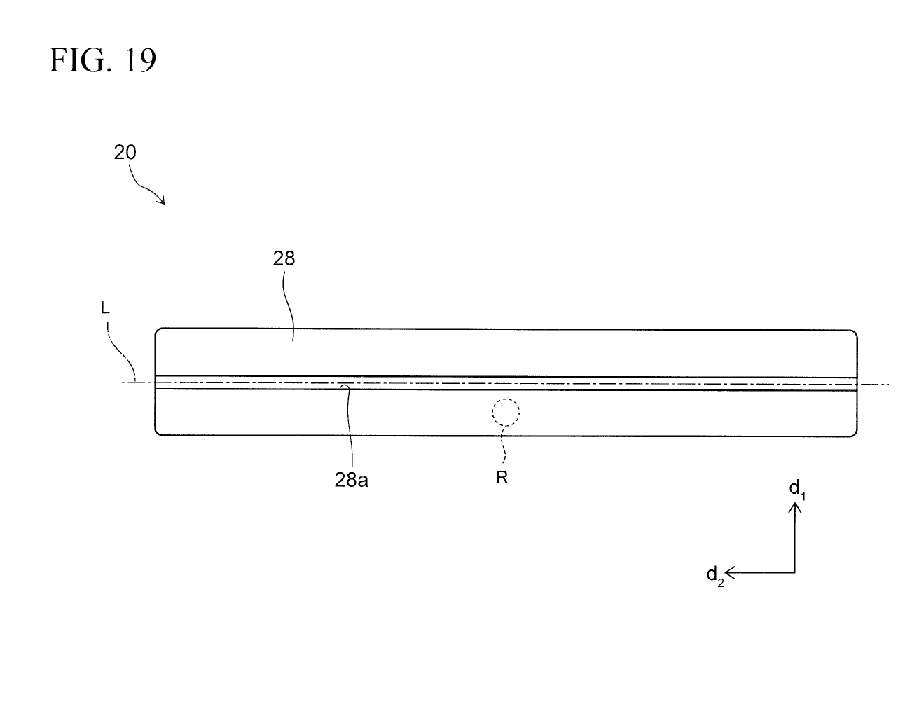

FIG. 19 is a plan view of an RFID tag 20 according to a sixth example.

In this example, a straight groove 28a extends in the longitudinal direction d₂ of the external member 28. Moreover, the chip mounting region R is provided in one of the two regions of the RFID tag 20 partitioned by the groove 28a.

This example is effective in the case where a fold L is formed in parallel to the longitudinal direction d₂.

Here, it is preferable to form the groove 28a across the entire length of the RFID tag 20 in order to make the RFID tag 20 easily foldable along the groove 28a.

### Seventh Example

In the example of FIG. 6, the grooves 28a are provided to the external members 28 on the front side and the back side respectively. However, the present embodiment is not limited to this.

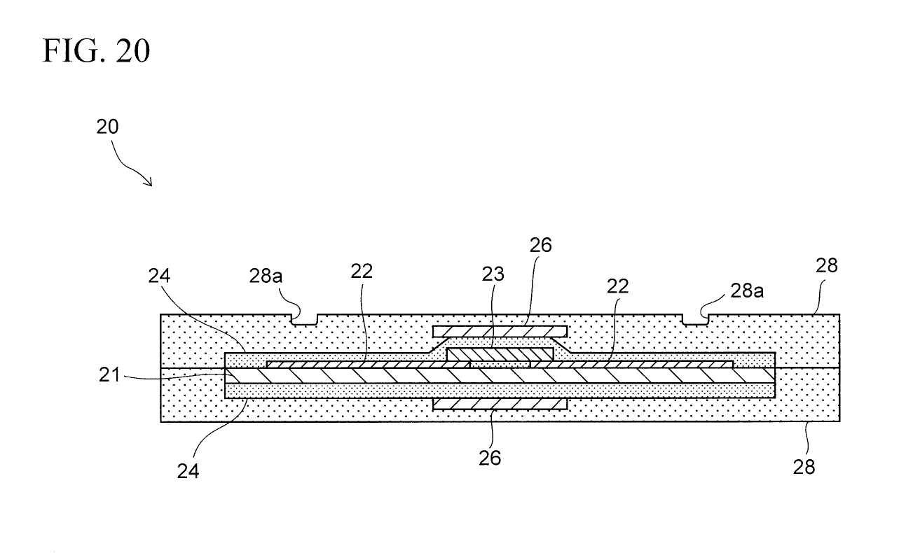

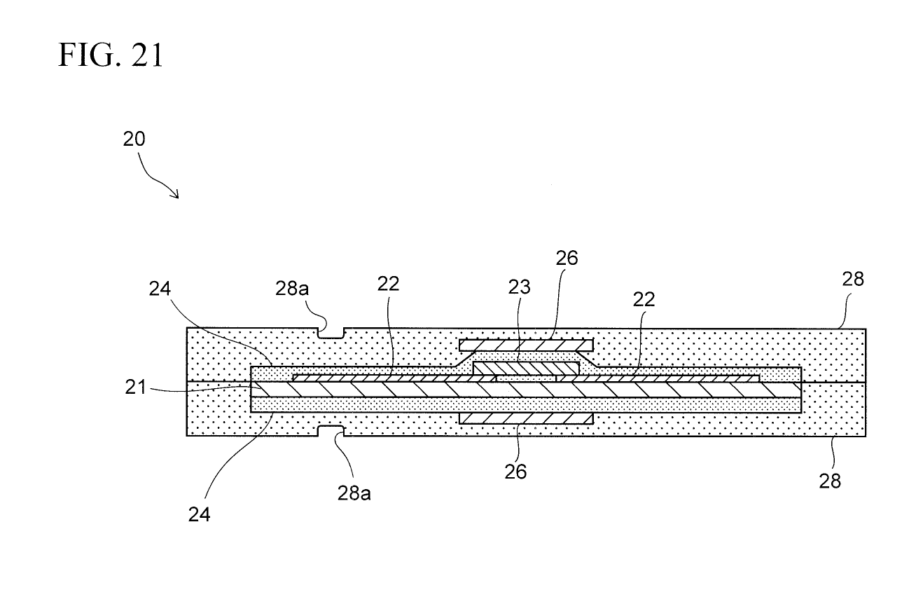

FIG. 20 is a cross-sectional view of an RFID tag 20 of this example, which is taken along its longitudinal direction. In FIG. 20, the same elements as those described in FIG. 6 will be denoted by the same reference numerals as in FIG. 6, and descriptions thereof will be omitted below. This is also the case for FIGS. 21 to 23 to be described later.

In this example, as illustrated in FIG. 20, the groove 28a is provided only to one of the external members 28 on the front and back sides.

By providing the grooves 28a only to one side of the RFID tag 20 in this manner, the RFID tag 20 can be folded along the groove 28a, while the groove 28a acts as the fold.

### Eighth Example

FIG. 21 is a cross-sectional view of an RFID tag 20 of this example, which is taken along its longitudinal direction. In this example, each of the external members 28 on the front and back sides is provided with one groove 28a, and the grooves 28a on the front and back sides are disposed to oppose each other.

By providing the groove 28a one by one on the front and back sides of the RFID tag 20, the RFID tag 20 can be folded along the groove 28a, while the groove 28a acts as the fold.

### Ninth Example

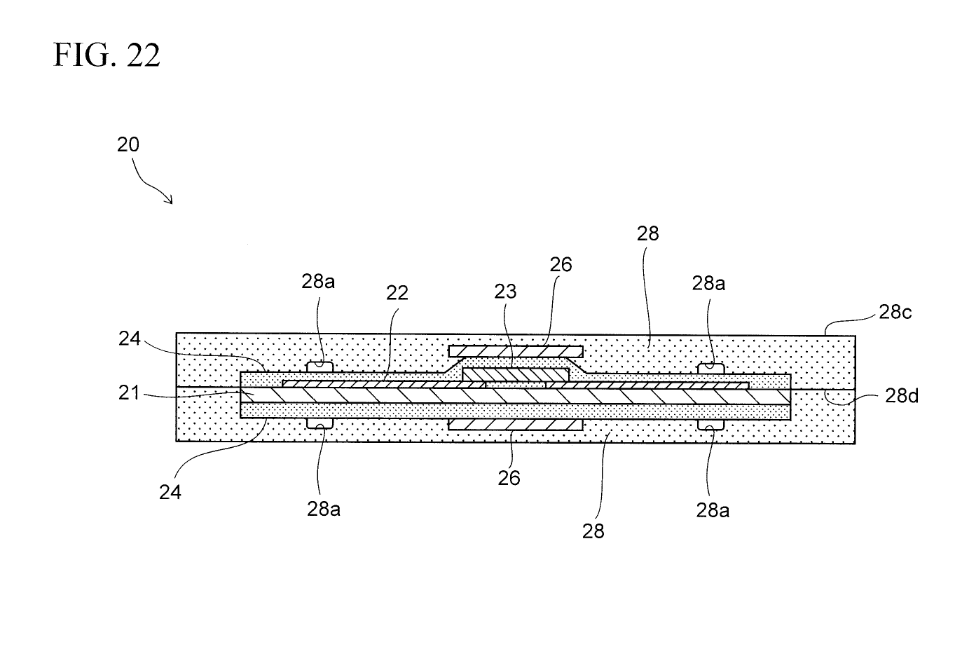

FIG. 22 is a cross-sectional view of an RFID tag 20 of this example, which is taken along its longitudinal direction.

In this example, of the two faces 28c and 28d of each external member 28, the grooves 28a are provided in the face 28d which is directed to the inlet base member 21.

Accordingly, the grooves 28a do not appear on the face 28c which attracts the attention of a user. Therefore, it is possible to prevent the external appearance of the RFID tag 20 from being defiled by the groove 28a.

### Tenth Example

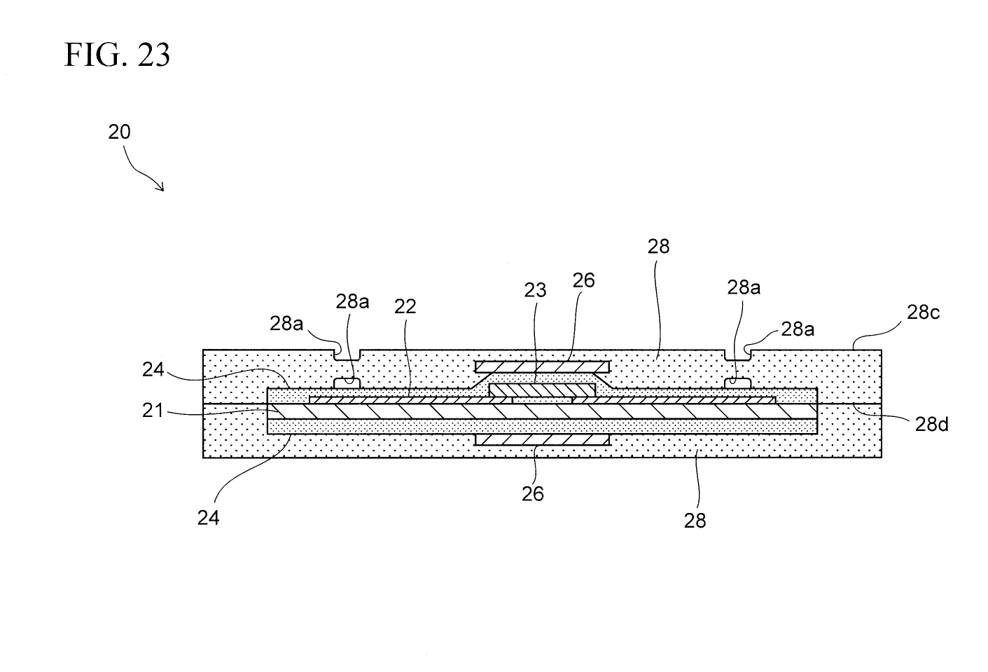

FIG. 23 is a cross-sectional view of an RFID tag 20 of this example, which is taken along its longitudinal direction.

In this example, the grooves 28a are provided to both of the faces 28c and 28d of the external member in such a way that grooves oppose each other. By providing the grooves 28a to oppose each other in this manner, the portion of the external member 28 where the grooves 28a are provided is reduced in thickness, and hence the RFID tag 20 can be bent more easily along the grooves 28a that acts as the folds.

### Eleventh Example

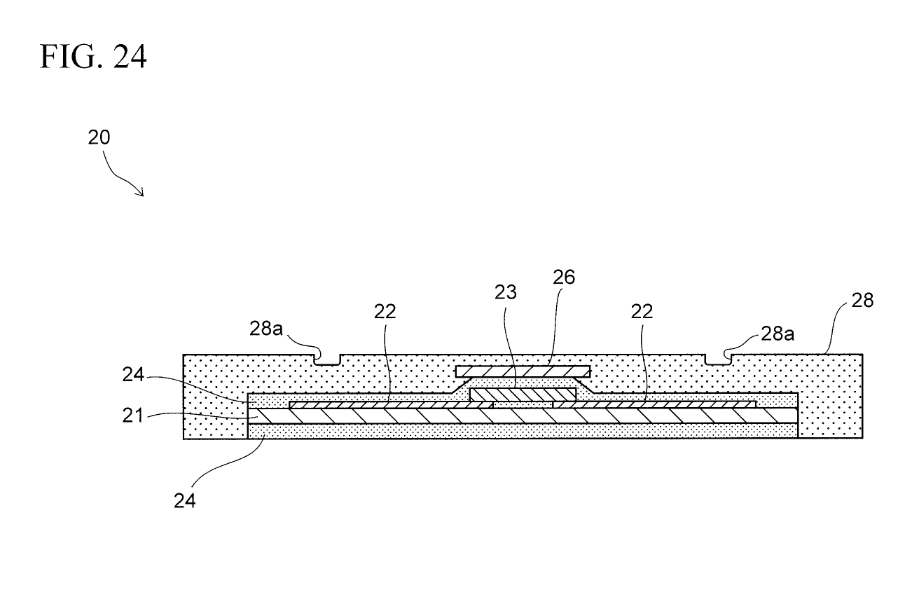

FIG. 24 is a cross-sectional view of an RFID tag 20 of this example, which is taken along its longitudinal direction.

In this example, of the front and back faces of the inlet base member 21, the external member 28 is provided only to the front face on which the semiconductor chip 23 is mounted, while the external member 28 is not provided on the back face of the inlet base member 21.

Even when the external member 28 is provided only to one of the front and back faces in this manner, it is still possible to fold the RFID tag 20 while using the grooves 28a in the external member 28 as the folds.

(Manufacturing Method)

Next, a method of manufacturing the RFID tag of the present embodiment will be described.

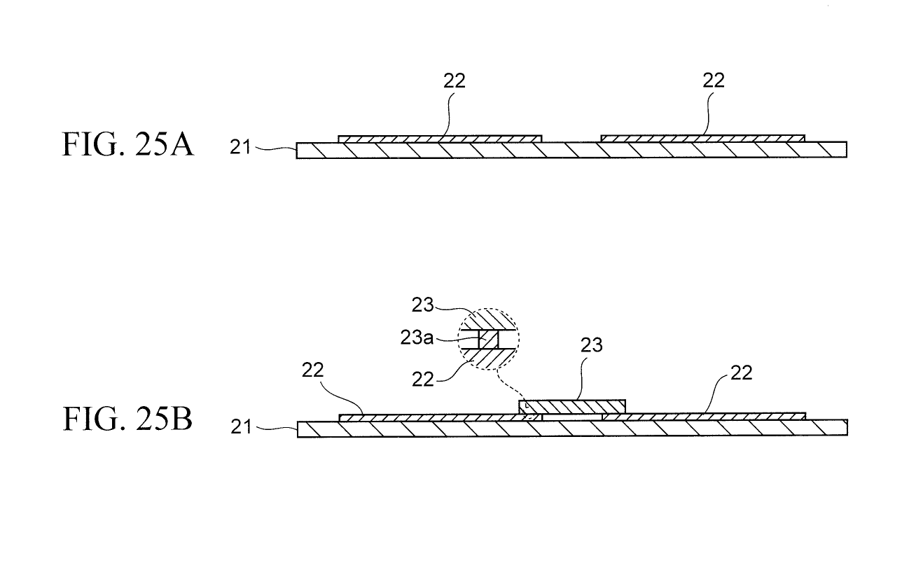

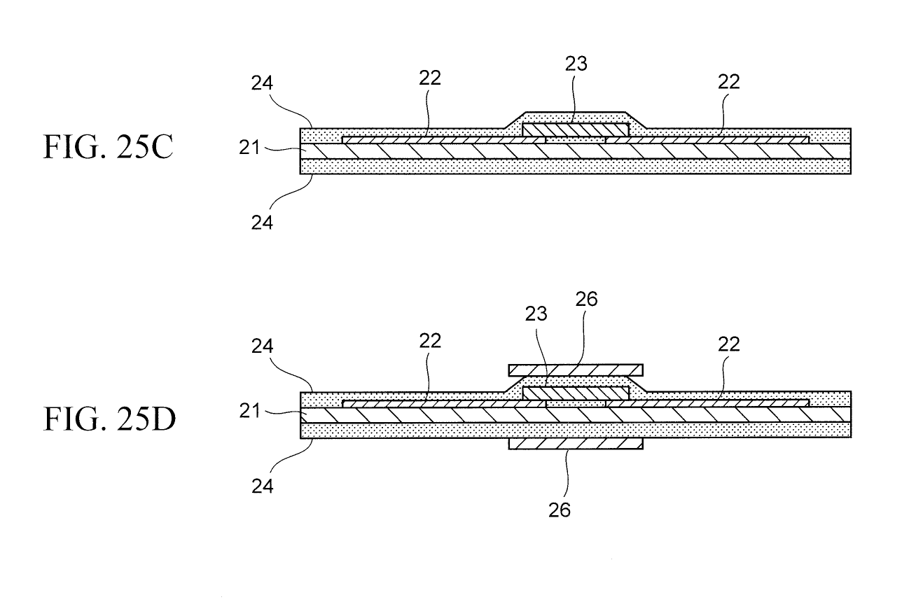

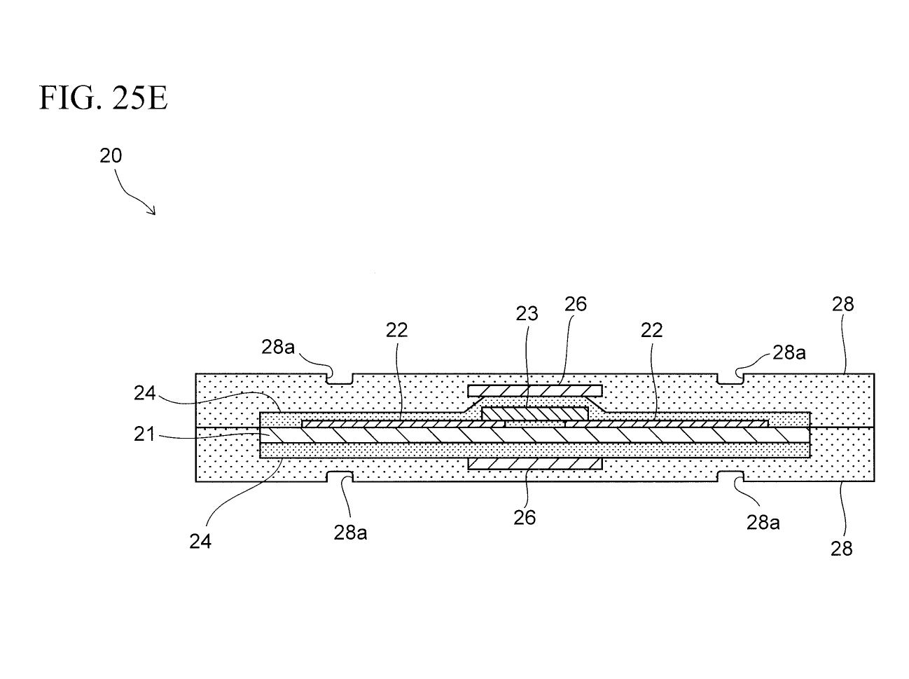

FIGS. 25A to 25E are cross-sectional views of the RFID tag of the present embodiment that is in the course of manufacturing.

First, as illustrated in FIG. 25A, a PET sheet of a thickness of 30 μm to 100 μm is prepared as the inlet base member 21. Then, a silver layer having a thickness of about 5 μm to 20 μm is formed on the inlet base member 21 by vapor deposition. Then, the silver layer thus formed is patterned into the conductive pattern 22.

Next, as illustrated in FIG. 25B, the semiconductor chip 23 is mounted on the conductive pattern 22. In this example, the conductive pattern 22 is connected to the semiconductor chip 23 through the terminals 23a such as solder bumps and gold bumps.

Subsequently, as illustrated in FIG. 25C, a PET sheet of a thickness of 50 μm to 300 μm serving as the protective sheet 24 is attached from the semiconductor chip 23 to the inlet base member 21. Likewise, the other protective sheet 24 is also attached to the back face of the inlet base member 21 on which the semiconductor chip 23 is not mounted.

The method of attachment includes, for example, a method of attaching the protective sheets 24 to the inlet base member 21 by using an unillustrated adhesive.

Next, as illustrated in FIG. 25D, the reinforcing members 26 are attached onto the protective sheets 24 on the front and back sides of the inlet base member 21 by using an unillustrated adhesive.

As described previously, the reinforcing members 26 play the role in inhibiting the RFID tag from being bent by the external force. In the present embodiment, a PET plate having a thickness of 100 μm to 300 μm is used as the reinforcing member 26.

Thereafter, as illustrated in FIG. 25E, elastic sheets made of rubber or the like are attached as the external members 28 onto the reinforcing members 26 on the front and back sides, thereby enclosing the inlet base member 21 and the semiconductor chip 23 by the external members 28. Here, the external members 28 on the front and back sides are attached together by molecular adhesion.

While the external members 28 are molded into the elongated shape in advance before this step, the above-described grooves 28a are also simultaneously formed when molding the external members 28. Accordingly, a dedicated process to form the grooves 28a is not required.

Thus, the basic structure of the RFID tag 20 of the present embodiment is completed.

According to the above-described method of manufacturing the RFID tag 20, the grooves 28a can be formed simultaneously with the molding of the external members 28. Therefore, it is possible to manufacture the RFID tag 20 which can prevent the semiconductor chip 23 from cracking, without causing an increase in the number of steps.

### Second Embodiment

In the first embodiment, the grooves 28a are provided to the external members 28 as illustrated in FIG. 10 and the like, and the RFID tag 20 is made foldable by making the grooves 28a into the folds L.

As described below, in the present embodiment, the RFID tag 20 is made foldable without forming the grooves.

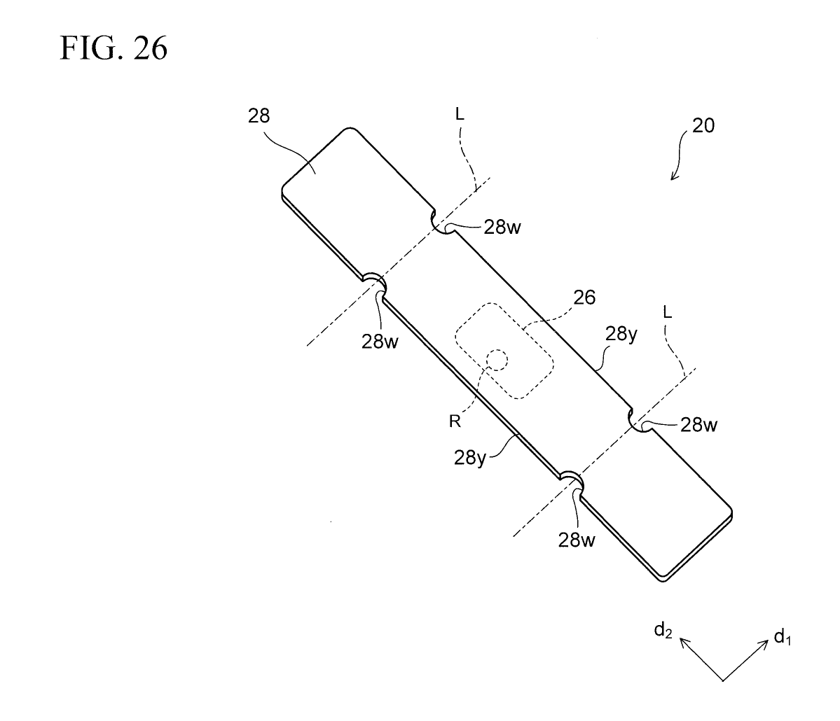

FIG. 26 is a perspective view of the RFID tag 20 of the present embodiment. Note that the elements in FIG. 26 which are the same as those explained in the first embodiment will be denoted by the same reference numerals as those in the first embodiment, and the their descriptions will be omitted below.

As illustrated in FIG. 26, in the present embodiment, recesses 28w are provided in side portions of the external member 28. The recesses 28w function as originating points of the folds L when the RFID tag 20 is bent, and the chip mounting region R is provided away from the folds L.

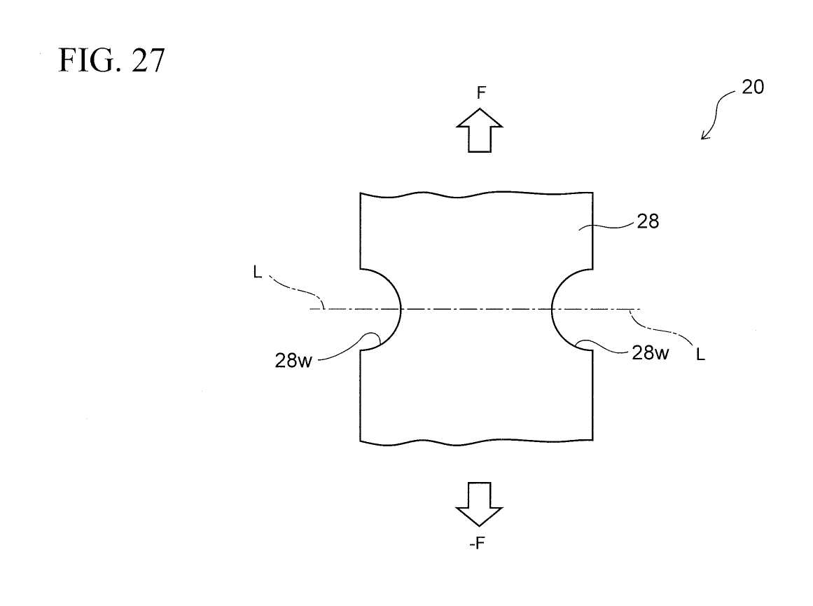

FIG. 27 is an enlarged plan view of the RFID tag for explaining the fold L.

When an external force F acts on the external member 28 provided with the recess 28w as illustrated in FIG. 27, a stress is concentrated more on the recess 28w than is on other portions. Therefore, the RFID tag 20 is folded preferentially along the fold L passing through the recess 28w.

Reference is made to FIG. 26 again.

As illustrated in FIG. 26, in this example, the plurality of recesses 28w are respectively provided to the two long sides 28y of the external member 28 in such a way that the recesses 28w are opposing each other. According to this configuration, the fold L extends in the lateral direction d₁ of the external member 28. As a consequence, the RFID tag 20 is folded back as in the case illustrated in FIG. 10 and FIG. 11 when the external force is applied to the RFID tag 20.

In addition, since the RFID tag 20 is folded preferentially along the fold L, the risk is reduced that the RFID tag 20 is bent in the chip mounting region R located away from the fold L. Therefore, it is possible to reduce the possibility that the semiconductor chip 23 (see FIG. 7) located in the region R is cracked.

Moreover, the recesses 28w are formed in the uppermost external member 28 in which the folds can easily be formed. Therefore, the RFID tag 20 can be folded more easily than the case of forming the recesses in the inlet base member 21 and the like located in the RFID tag 20.

Moreover, since the rubber used as the material of the external member 28 has sufficient elasticity, there is little risk that the external member 28 is cut from the recesses 28w when the RFID tag 20 is folded.

Note that the size and shape of the recess 28w is not particularly limited as long as the recess 28w can serve as the originating point of the fold L. In this example, a planar shape of the recess 28w is formed into a semicircular shape.

Furthermore, the positional relation between the chip mounting region R and the fold L is not limited only to the example of FIG. 26.

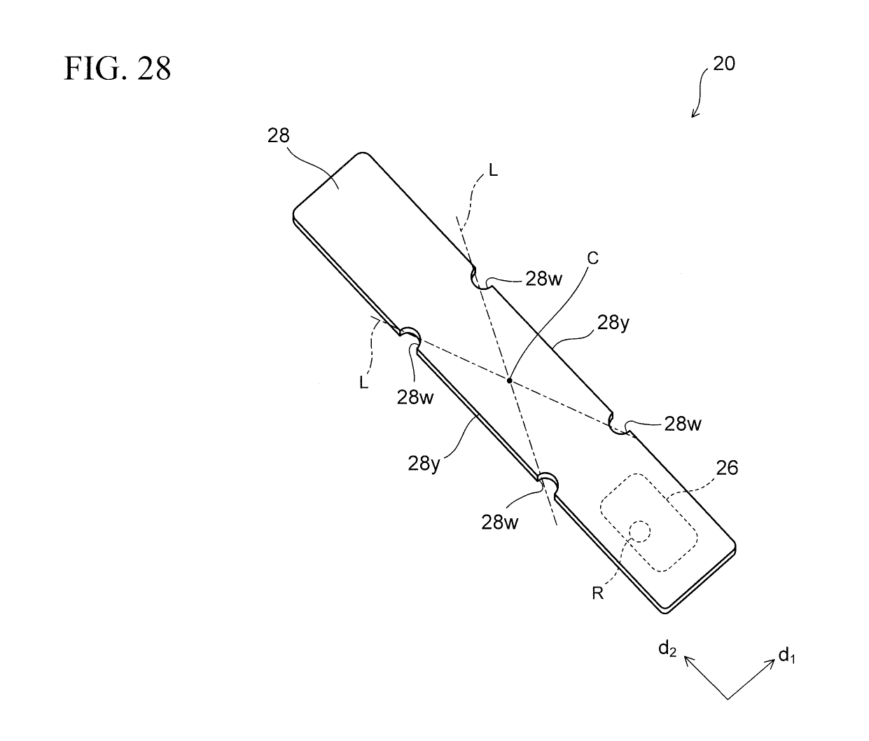

FIG. 28 is a perspective view for explaining another example of the positional relation between the chip mounting region R and folds L.

This example assumes the case where the two folds L originating from the recesses 28w cross each other as the RFID tag 20 is twisted.

In this case, it is preferable to shift the position of the chip mounting region R in the longitudinal direction d₂ and away from an intersecting point C of the folds L in order to prevent the semiconductor chip 23 located in the chip mounting region R from cracking.

All examples and conditional language recited herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An RFID tag comprising:
a base member;
a semiconductor chip mounted over the base member; and
an external member covering the base member and the semiconductor chip, a surface of the external member being provided with a groove at a position away from the semiconductor chip, the groove serving as a fold when the external member is folded.

2. The RFID tag according to claim 1, wherein
the external member has an elongated shape, and
the groove extends obliquely to a longitudinal direction of the external member.

3. The RFID tag according to claim 2, wherein
the number of the grove is two, and
the two grooves cross each other.

4. The RFID tag according to claim 2, wherein
the groove extends from a long side of the external member to another long side of the external member.

5. The RFID tag according to claim 2, wherein
the groove extends from a short side of the external member to a long side of the external member.

6. The RFID tag according to claim 4, further comprising:
a reinforcing member provided over the semiconductor chip and configured to reinforce the base member, wherein
the groove and the long side cross each other in the vicinity of a corner of the reinforcing member.

7. The RFID tag according to claim 2, wherein the groove extends from a short side of the external member to another short side of the external member.

8. The RFID tag according to claim 1, wherein
the external member has an elongated shape, and
the groove extends in a lateral direction of the external member.

9. The RFID tag according to claim 8, further comprising:
a reinforcing member provided over the semiconductor chip and configured to reinforce the base member, wherein
the groove is located at equal distances from a short side of the external member and from the reinforcing member.

10. The RFID tag according to claim 8, further comprising:
a reinforcing member provided over the semiconductor chip and configured to reinforce the base member, wherein
the groove is located at a position away from the reinforcing member but closer to the reinforcing member than to the short side of the external member.

11. The RFID tag according to claim 1, wherein
the external member has an elongated shape, and
the groove extends in a longitudinal direction of the external member.

12. The RFID tag according to claim 1, wherein the surface of the external member and the groove are directed to the base member.

13. The RFID tag according to claim 1, wherein
the external members are respectively provided over a front face and a back face of the base member, and
the groove in the external member of the front face and the groove in the external member of the back face are opposed each other.

14. An RFID tag comprising:
a base member;
a semiconductor chip mounted over the base member; and
an external member covering the base member and the semiconductor chip, a side portion of the external member being provided with a recess, the recess serving as an originating point of a fold such that the fold is formed away from the semiconductor chip when the external member is folded.

15. The RFID tag according to claim 14, wherein
the external member has an elongated shape, and
each of the two long sides of the external member is provided with the plurality of the recesses in such a way that the recesses are opposed each other.

16. The RFID tag according to claim 15, wherein
a plurality of the folds originating from a plurality of the recesses cross each other, and
a position of the semiconductor chip is shifted from an intersecting point of the plurality of the folds in a longitudinal direction of the external member.
